(19) United States
(12) Patent Application Publication
(10) Pub. No.: US 2010/0073111 A1
(43) Pub. Date: Mar. 25, 2010

(54) TEM MODE RESONATOR

(76) Inventors: Nicholas Archer, Ikley (GB); Christopher Mobbs, West Yorkshire (GB)

Correspondence Address: HOWARD & HOWARD ATTORNEYS PLLC, 450 West Fourth Street, Royal Oak, MI, 48067, US

(21) Appl. No.: 12/523,225

(22) PCT Filed: Jan. 7, 2008
(86) PCT No.: PCT/GB08/00036

§ 371 Date: Dec. 4, 2009

(30) Foreign Application Priority Data
Jan. 15, 2007 (GB) 0700730.5

(51) Int. Cl. H01P 7/06

(52) U.S. Cl. 333/232

(57) ABSTRACT

A TEM mode resonator includes a tuneable cavity defined by an electrically conducting cavity wall. The cavity wall includes a grounding face, a capacitor face and a surrounding wall extending therebetween. An electrically conducting resonator member is disposed within the cavity and extends from the grounding face part way towards the capacitor face. A portion of the resonator member proximate to the capacitor face includes a recess defining an aperture. A tuning mechanism disposed outside the tuneable cavity, includes a tuning arm extending into the tuneable cavity through the aperture. The tuning mechanism is adapted to displace the tuning arm towards and away from the capacitor face. At least a portion of the tuning arm disposed within the cavity is the tuning element, which is formed of either a metal or a dielectric.

This application claims priority to and all the advantages of International Application No. PCT/GB2008/000036, filed on Jan. 7, 2008, which claims priority to Great Britain Patent Application No. 0700730.5, filed on Jan. 15, 2007.

The present invention relates to a TEM mode resonator. More particularly, but not exclusively, the present invention relates to a TEM mode resonator having a resonator member within a tuneable cavity, the resonator member having a recess with an aperture therein and a tuning arm extending through the aperture into the cavity to tune the cavity.

There are many requirements which require a microwave filter constructed from resonant cavities to be remotely tuned according to a system configuration. In transmitters where there is a high power requirement, electronic tuning mechanisms distort the signals and hence tuning is normally achieved using electromechanical methods. One common method is to use a stepper motor where accurate position information can be obtained electronically.

Typically the stepper motor displaces a tuning rod into and out of the tuning cavity through an aperture to tune the resonator. The gap between the tuning rod and the aperture results in microwave signal leakage. U.S. Pat. No. 7,078,990 B1 discloses a complex mechanism to overcome this problem which increases cost and reduces reliability.

The TEM mode resonator according to the invention seeks to overcome this problem.

Accordingly, in a first aspect, the present invention provides a TEM mode resonator comprising

a tuneable cavity defined by an electrically conducting cavity wall, the cavity wall comprising a grounding face, a capacitor face and a surrounding wall extending therebetween;

an electrically conducting resonator member within the cavity and extending from the grounding face part way to the capacitor face;

a portion of the resonator member proximate to the capacitor face comprising a recess having an aperture therein;

a tuning mechanism outside the tuneable cavity, the tuning mechanism comprising a tuning arm extending into the tuneable cavity through the aperture, the tuning mechanism being adapted to displace the tuning arm towards and away from the capacitor face,

at least a portion of the tuning arm within the cavity being a tuning element, the tuning element being either a metal or a dielectric.

The aperture through which the tuning arm extends is positioned within a recess in the electrically conducting resonator member. The aperture is therefore shielded from the electric field within the tuneable cavity and hence there is no microwave signal leakage from the tuneable cavity.

Preferably, the tuning arm is a dielectric. Alternatively, the tuning arm is a metal.

Preferably, the tuning arm is of uniform cross section along its length.

The tuning arm can comprise a tuning element and a tuning rod extending between tuning element and tuning mechanism, the cross section of the tuning element being larger than that of the rod.

The tuning element can be a disk.

The tuning rod can be any one of a metal, a dielectric or a plastics material.

The tuning element can be a dielectric.

Preferably, both the tuning rod and tuning element are dielectric materials, the dielectric constant of the tuning element being larger than that of the tuning rod.

Alternatively, the tuning element is a metal.

Preferably, the tuning element comprises a recess in its face proximate to the capacitor face.

Preferably, the tuning mechanism is adapted to displace the tuning element from a retracted position at least partially within the resonator member recess towards the capacitor plate to an extended position.

Preferably, the tuning arm is adapted such that the resonant frequency of the resonator is a linear function of position of the tuning arm within the tuneable cavity.

Preferably, the tuning mechanism is arranged within the resonator member.

The present invention will now be described by way of example only and not in any limitative sense with reference to the accompanying drawings in which

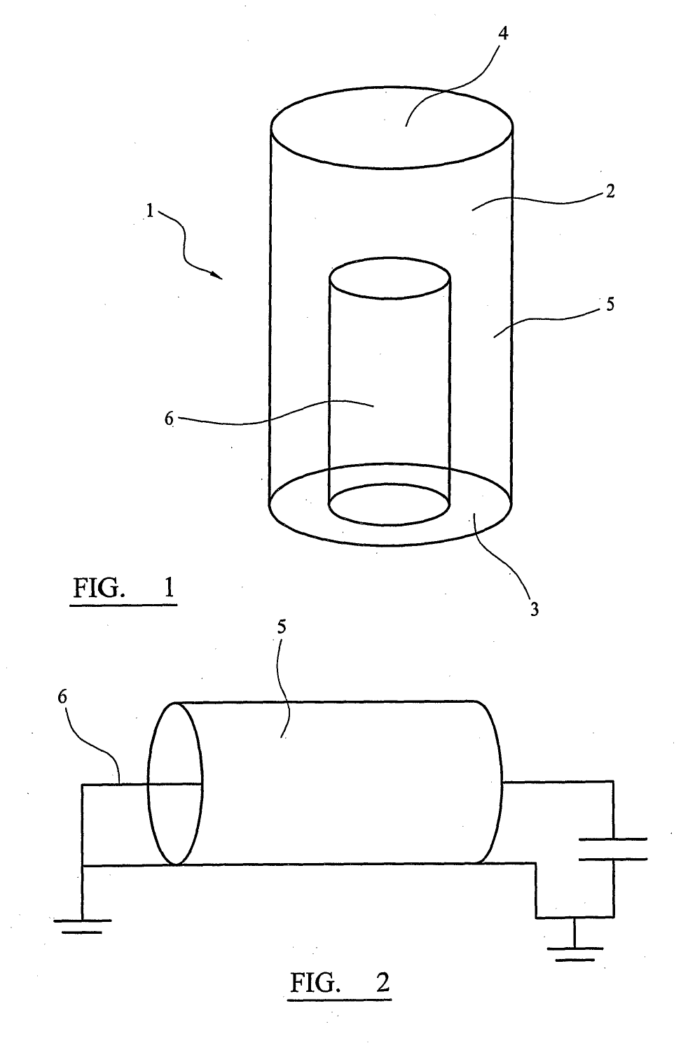

FIG. 1 shows in schematic view a known TEM mode microwave resonator;

FIG. 2 shows an equivalent circuit for FIG. 1;

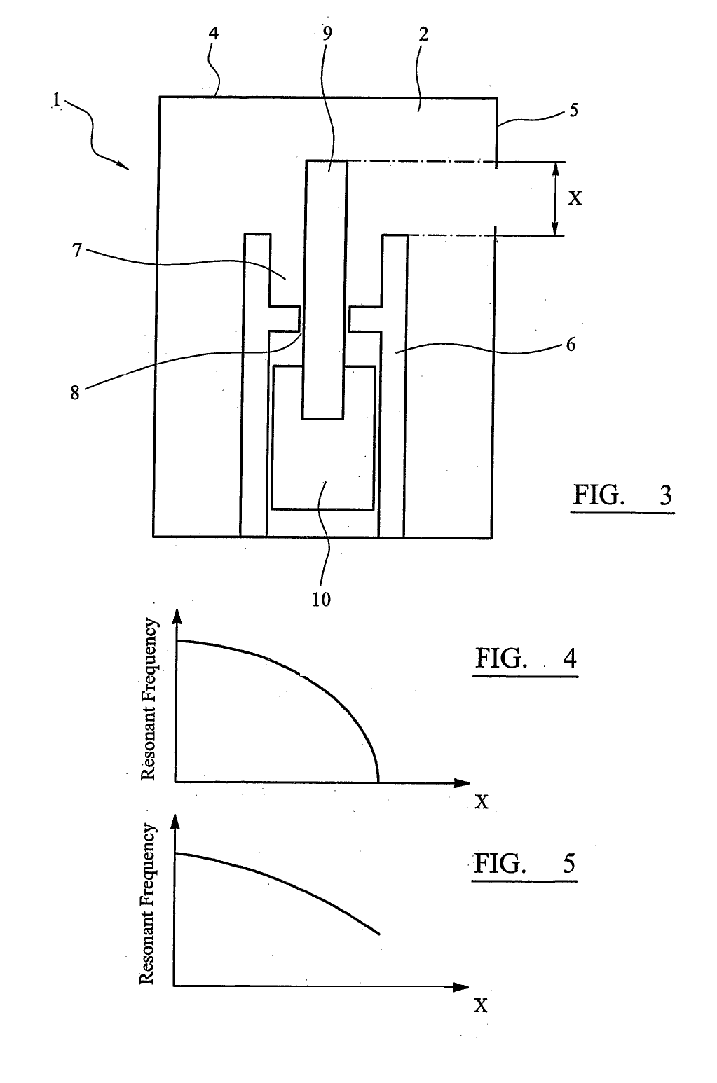

FIG. 3 shows a TEM mode resonator according to the invention in cross section;

FIG. 4 is a plot of resonant frequency against tuning arm displacement for the embodiment of FIG. 3 with a metal tuning arm;

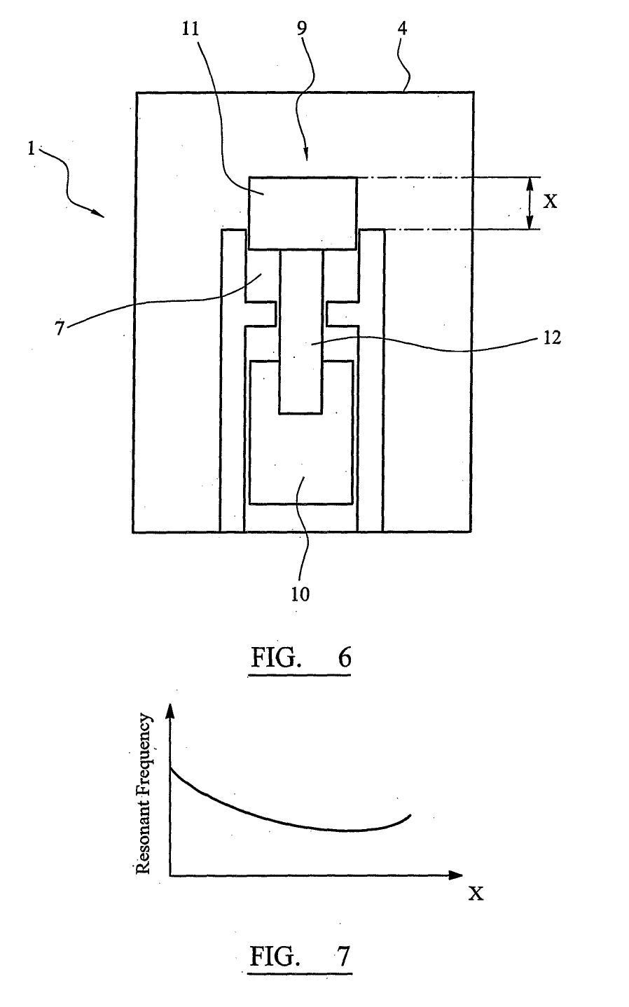

FIG. 5 is plot of resonant frequency against tuning arm displacement for the embodiment of FIG. 3 with a dielectric tuning arm;

FIG. 6 shows a further embodiment of a TEM mode resonator according to the invention in cross section;

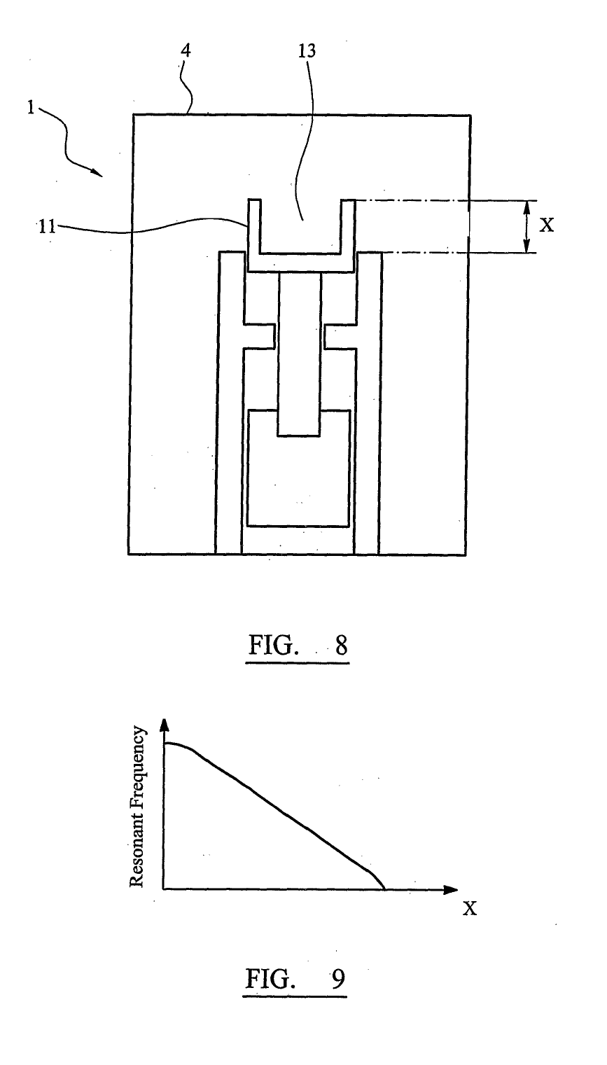

FIG. 7 is a plot of resonant frequency against tuning arm displacement for the embodiment of FIG. 6;

FIG. 8 shows a further embodiment of a TEM mode resonator according to the invention in cross section; and,

FIG. 9 shows a plot of resonant frequency against tuning arm displacement for the embodiment of FIG. 8.

Shown in FIG. 1 is a schematic view of a TEM mode microwave resonator 1. The microwave resonator 1 comprises a tuneable cavity 2 defined by a grounding face 3 and a capacitor face 4 and a surrounding wall 5 extending therebetween. All of the grounding face 3, capacitor face 4 and surrounding wall 5 are electrically conducting.

Positioned within the tuneable cavity 2 is a resonator member 6. The resonator member 6 extends from the grounding face 3 part way towards the capacitor face 4. In this example the tuneable cavity 2 and resonator member 6 are both cylindrical. Other variations are possible such as rectangular for either of both of the tuneable cavity 2 or resonator member 6.

The surrounding wall 5 includes input and output ports (not shown) for the entry and exit of microwaves.

The resonator member 6 and surrounding wall 5 acts as a transmission line short circuited at one end by the grounding face 3. At the other end of the transmission line the capacitor face 4 and end of the resonator member 6 act as a capacitor. The equivalent circuit for the resonator 1 of FIG. 1 is shown in FIG. 2.

The resonant frequency of the circuit of FIG. 2 depends upon the length of the resonator 1 and also the effective capacitance between capacitor face 4 and resonator member 6. Increasing either decreases the resonant frequency of the resonator 1.

It is known to tune such resonators 1 by displacement of a tuning arm (not shown) (typically dielectric or metal) within the tuneable cavity 2. The tuning arm extends though an aperture in the tuneable cavity 2 to a tuning mechanism (not shown) outside the tuneable cavity 2 which displaces the tuning arm. Microwave energy escapes though the aperture in the gap between the tuning arm and surrounding wall 5.

Shown in FIG. 3 in cross section is a TEM mode resonator 1 according to the invention. The resonator 1 is similar to that of figure one except the resonator member 6 includes a recess 7 proximate to the capacitor face 4. Positioned within the recess 7 is the aperture 8. Extending through the aperture 8 is the tuning arm 9. A tuning mechanism 10 outside the tuneable cavity 2 displaces the tuning arm 9 into and out of the tuneable cavity 2 to tune the resonator 1.

In this embodiment the tuning arm 9 is a dielectric rod of uniform cross section. In an alternative embodiment the tuning arm 9 is a metal rod of uniform cross section. Tuning arms 9 of non uniform cross section are also possible in alternative embodiments (not shown). By altering the cross section of the tuning arm 9 as a function of position along the arm 9 one can adjust the shape of the resonant frequency against tuning arm displacement curve as described in more detail below.

Because the aperture 8 is shielded within a recess 7 in the resonator member 6 no microwave energy escapes though it. In addition, with this geometry the tuning mechanism 10 can be arranged in the resonator member 6 so reducing the size of the resonator/tuning mechanism assembly.

Shown in FIG. 4 in schematic form is the resonant frequency of the resonator 1 with a metal tuning arm 9. As the metal tuning arm 9 is moved towards the capacitor face 4 the capacitance between the two increases, decreasing the resonant frequency. The resonant frequency rapidly decreases as the tuning arm 9 approaches the capacitor face 4 reaching zero as the two touch.

Shown in FIG. 5 is a similar plot this time with a dielectric tuning arm 9. The change in resonant frequency with tuning arm displacement is more linear with a dielectric tuning arm 9.

Shown in FIG. 6 is a further embodiment of a TEM resonator 1 according to the invention. In this embodiment the tuning arm 9 comprises a tuning element 11 and a tuning rod 12 extending between tuning element 11 and tuning mechanism 10. The tuning element 11 is a disk having a larger cross section than the tuning rod 12. The disk is dimensioned to fit within the recess 7. The tuning mechanism 10 is adapted to displace the disk 11 from a position where it is at least partly within the recess 7 to a forward position closer to the capacitor face 4.

In this embodiment both the tuning rod 12 and tuning element 11 are dielectric materials, with the tuning element 11 having a higher dielectric constant than the tuning rod 12. In alternative embodiments the tuning element 11 can be either a dielectric or a metal. Similarly, in other embodiments, the tuning rod 12 can be any of a plastics material, dielectric or a metal.

In other embodiments the tuning element 11 can be other shapes in cross section such as square.

Shown in FIG. 7 is a plot of resonant frequency as a function of displacement for the embodiment of FIG. 6. The exact shape of the curve depends upon the relative sizes and dielectric constants of the tuning rod 12 and tuning element 11 portions.

Shown in FIG. 8 is a further embodiment of a TEM mode resonator 1 according to the invention. In this embodiment the tuning element 11 includes a recess 13 in the face proximate to the capacitor face 4. The resulting plot of resonant frequency as a function of tuning arm position is shown in FIG. 9. This plot is somewhere between that of FIG. 7 and FIG. 5. By correctly dimensioning the tuning element 11 and tuning rod 12 portions the rate of change of tuning frequency with position of the tuning arm 9 can be arranged to be approximately constant over a large range of displacement of the tuning arm 9.

1. A TEM mode resonator comprising
a tuneable cavity defined by an electrically conducting cavity wall, the cavity wall comprising a grounding face, a capacitor face and a surrounding wall extending therebetween;
an electrically conducting resonator member within the cavity and extending from the grounding face part way to the capacitor face;
a portion of the resonator member proximate to the capacitor face comprising a recess having an aperture therein; and
a tuning mechanism outside the tuneable cavity, the tuning mechanism comprising a tuning arm extending into the tuneable cavity through the aperture, the tuning mechanism being adapted to displace the tuning arm towards and away from the capacitor face, and wherein
at least a portion of the tuning arm within the cavity being a tuning element, the tuning element being at least one of a metal and a dielectric.

2. A TEM mode resonator as claimed in claim 1, wherein the tuning arm is a dielectric.

3. A TEM mode resonator as claimed in claim 1, wherein the tuning arm is a metal.

4. A TEM mode resonator as claimed in claim 1, wherein the tuning arm is of uniform cross section along its length.

5. A TEM mode resonator as claimed in claim 1, wherein the tuning arm includes a tuning rod extending between the tuning element and the tuning mechanism, a cross section of the tuning element being larger than a cross section of the tuning rod.

6. A TEM mode resonator as claimed in claim 5, wherein the tuning element is a disk.

7. A TEM mode resonator as claimed in claim 6, wherein the tuning rod is at least one of a metal, a dielectric and a plastics material.

8. A TEM mode resonator as claimed in claim 7, wherein the tuning element is a dielectric.

9. A TEM mode resonator as claimed in claim 8, wherein both the tuning rod and tuning element are dielectric materials, a dielectric constant of the tuning element being larger than a dielectric constant of the tuning rod.

10. A TEM mode resonator as claimed in claim 7, wherein the tuning element is a metal.

11. A TEM mode resonator as claimed in claim 5, wherein the tuning element comprises a recess in its face proximate to the capacitor face.

12. A TEM mode resonator as claimed in claim 1, wherein the tuning mechanism is adapted to displace the tuning element from a retracted position at least partially within the resonator member recess towards the capacitor plate to an extended position.

13. A TEM mode resonator as claimed in claim 12, wherein the tuning arm is adapted such that the resonant frequency of the resonator is a linear function of position of the tuning arm within the tuneable cavity.

14. A TEM mode resonator as claimed in claim 1, wherein the tuning mechanism is arranged within the resonator member.

15. A TEM mode resonator as claimed in claim 5, wherein both the tuning rod and the tuning element are dielectric materials, a dielectric constant of the tuning element being larger than a dielectric constant of the tuning rod.

16. A TEM mode resonator as claimed in claim 15, wherein the tuning element is a disk.
